(19) United States
(12) Patent Application Publication
(10) Pub. No.: US 2019/0204904 A1
(43) Pub. Date: Jul. 4, 2019

(54) CONTROL METHOD, APPARATUS AND SYSTEM FOR WEARABLE DEVICE

(71) Applicant: BOE Technology Group Co., Ltd., Beijing (CN)

(72) Inventors: Zhusong Yi, Beijing (CN); Weiguo Li, Beijing (CN)

(73) Assignee: BOE TECHNOLOGY GROUP CO., LTD.

(21) Appl. No.: 16/018,480

(22) Filed: Jun. 26, 2018

(30) Foreign Application Priority Data
Jan. 2, 2018 (CN) 201810003174.1

(51) Int. Cl. G06F 3/01; G06F 1/16; G06F 3/0488; G02B 27/01

(52) U.S. Cl. CPC G06F 3/011; G02B 27/017; G06F 3/04883; G06F 1/165

(57) ABSTRACT

A control method, apparatus and system for a wearable device are provided. The method includes: establishing a communication connection with a control terminal, the communication connection being established based on a connection establishment request carrying a direct connection control identifier; sending display data of a display interface to the control terminal, the control terminal being configured to display the display interface on a display screen according to the display data; receiving an operation instruction sent by the control terminal, the operation instruction being generated by the control terminal according to a received control operation for the display interface; and responding to the operation instruction. The control methods for the wearable device are diverse and the flexibility of use thereof is high.

This application claims priority to Chinese Patent Application No. 201810003174.1, filed with the State Intellectual Property Office on Jan. 2, 2018 and titled “CONTROL METHOD, APPARATUS AND SYSTEM FOR WEARABLE DEVICE,” the entire contents of which are incorporated herein by reference.

### TECHNICAL FIELD

The present disclosure relates to a control method, apparatus and system for wearable device.

### BACKGROUND

With the continuous development of science and technology, wearable devices such as smart glasses have been more and more widely used.

In the related art, a display screen may be provided on the lenses of the smart glasses. A touchpad may be provided on the frame of the smart glasses. The smart glasses may receive a user's touch operation through the touchpad, and control the widgets shown on the display screen according to the touch operation.

However, due to the small size of the touchpad of the smart glasses, the types of the touch operations that the smart glasses can receive and recognize are limited, resulting in a relatively simple control method for the smart glasses and poor use flexibility thereof.

### SUMMARY

The present disclosure provides a control method, apparatus and system for wearable device.

In an aspect, there is provided a control method for a wearable device, which is applied to the wearable device, the control method comprising steps of: establishing a communication connection with a control terminal, the communication connection being established based on a connection establishment request carrying a direct connection control identifier; sending display data of a display interface to the control terminal, the control terminal being configured to display the display interface on a display screen according to the display data; receiving an operation instruction sent by the control terminal, the operation instruction being generated by the control terminal according to a received control operation for the display interface; and responding to the operation instruction.

Optionally, said step of sending the display data of the display interface to the control terminal comprises: obtaining the display data of the display interface; and sending the display data to the control terminal after being processed according to a streaming media protocol.

Optionally, a display screen is provided in the wearable device, and the operation instruction comprises a first display parameter of the display screen of the control terminal, a type of the control operation, and coordinates of an acting point of the control operation on the display screen of the control terminal; said step of responding to the operation instruction comprises: performing a coordinate conversion on the coordinates to obtain corrected coordinates according to the first display parameter and a second display parameter of the display screen of the wearable device; and responding to the operation instruction according to the type of the control operation and the corrected coordinates.

Optionally, both the first display parameter and the second display parameter are resolution; said step of performing a coordinate conversion on the coordinates according to the first display parameter and the second display parameter of the display screen of the wearable device comprises: performing a coordinate conversion on the coordinates according to a ratio of the first display parameter and the second display parameter.

Optionally, said step of establishing the communication connection with the control terminal comprises: receiving the connection establishment request sent by the control terminal, the connection establishment request being sent after the control terminal scans an identification code labelled on the wearable device to obtain a device identifier of the wearable device; and establishing the communication connection with the control terminal based on the connection establishment request.

Optionally, said step of sending the display data of the display interface to the control terminal comprises: detecting whether the connection establishment request carries an operation control identifier for indicating to control the wearable device; and sending the display data to the control terminal when it is detected that the connection establishment request carries the operation control identifier.

Optionally, said step of establishing the communication connection with the control terminal comprises: scanning an identification code labelled on the control terminal to obtain a device identifier of the control terminal; and sending the connection establishment request to the control terminal to establish the communication connection with the control terminal according to the device identifier of the control terminal.

In another aspect, there is provided a control method for a wearable device, which is applied to a control terminal, the control method comprising steps of: establishing a communication connection with the wearable device, the communication connection being established based on a connection establishment request carrying a direct connection control identifier; displaying a display interface on a display screen according to display data of the display interface sent by the wearable device; generating an operation instruction according to a received control operation for the display interface, wherein the control operation comprises at least one of a touch operation and a voice operation; and sending the operation instruction to the wearable device.

Optionally, said step of displaying the display interface on the display screen according to the display data of the display interface sent by the wearable device comprises: processing the display data according to a streaming media protocol; and displaying the display interface on the display screen based on the processed display data.

Optionally, said step of establishing the communication connection with the wearable device comprises: scanning an identification code labelled on the wearable device to obtain a device identifier of the wearable device; and sending the connection establishment request to the wearable device to establish the communication connection with the wearable device according to the device identifier.

Optionally, said step of establishing the communication connection with the wearable device comprises: receiving the connection establishment request sent by the wearable device, wherein the connection establishment request is sent after the wearable device scans an identification code labelled on the control terminal to obtain a device identifier of the control terminal; and establishing the communication connection with the wearable device based on the connection establishment request.

Optionally, wherein a display screen is provided in the wearable device, and said step of generating an operation instruction according to a received control operation comprises: obtaining a second display parameter of the display screen of the wearable device; performing a coordinate conversion on the coordinates of an acting point of the control operation on the display screen of the control terminal to obtain corrected coordinates according to a first display parameter of the display screen of the control terminal and the second display parameter; and generating the operation instruction according to a type of the control operation and the corrected coordinates.

Optionally, both the first display parameter and the second display parameter are resolution; said step of performing a coordinate conversion on the coordinates according to the second display parameter of the display screen of the control terminal and the first display parameter comprises: performing a coordinate conversion on the coordinates according to a ratio of the first display parameter and the second display parameter.

In another aspect, there is provided a control apparatus for a wearable device, which is applied to the control terminal for implementing the control method.

Optionally, the apparatus comprises: a connection module configured to establish a communication connection with a control terminal, the communication connection being established based on a connection establishment request carrying a direct connection control identifier; a sending module configured to send display data of a display interface to the control terminal, the control terminal is configured to display the display interface on a display screen according to the display data; a receiving module configured to receive an operation instruction sent by the control terminal, the operation instruction being generated by the control terminal according to a received control operation for the display interface; and a responding module configured to respond to the operation instruction.

Optionally, the sending module is configured to: obtain the display data of the display interface; and send the display data to the control terminal after being processed according to a streaming media protocol.

Optionally, a display screen is provided in the wearable device, and the operation instruction comprises a first display parameter of the display screen of the control terminal, a type of the control operation, and coordinates of an acting point of the control operation on the display screen of the control terminal; the responding module is configured to: perform a coordinate conversion on the coordinates to obtain corrected coordinates according to the first display parameter and a second display parameter of the display screen of the wearable device; and respond to the operation instruction according to the type of the control operation and the corrected coordinates.

Optionally, both the first display parameter and the second display parameter are resolution; performing a coordinate conversion on the coordinates according to the first display parameter and the second display parameter of the display screen of the wearable device comprises: performing a coordinate conversion on the coordinates according to a ratio of the first display parameter and the second display parameter.

Optionally, the connection module is configured to: receive the connection establishment request sent by the control terminal, wherein the connection establishment request is sent after the control terminal scans an identification code labelled on the wearable device to obtain a device identifier of the wearable device; and establish the communication connection with the control terminal based on the connection establishment request.

Optionally, the sending module is configured to: detect whether the connection establishment request carries an operation control identifier for indicating to control the wearable device; and send the display data to the control terminal when it is detected that the connection establishment request carries the operation control identifier.

In still yet another aspect, there is provided a control apparatus for a wearable device, which is applied to a control terminal. The apparatus is configured to implement the control method for the wearable device of the control terminal.

Optionally, the apparatus comprises: a connection module configured to establish a communication connection with a wearable device, the communication connection being established based on a connection establishment request carrying a direct connection control identifier; a display module configured to display a display interface on a display screen according to display data of the display interface sent by the wearable device; a generating module configured to generate an operation instruction according to a received control operation for the display interface, wherein the control operation comprises at least one of a touch operation and a voice operation; and a sending module configured to send the operation instruction to the wearable device.

Optionally, the display module is configured to process the display data according to a streaming media protocol; and display the display interface on the display screen of the control terminal based on the processed display data.

Optionally, the connection module is configured to: scan an identification code labelled on the wearable device to obtain a device identifier of the wearable device; and send the connection establishment request to the wearable device to establish the communication connection with the wearable device according to the device identifier.

Optionally, a display screen is provided in the wearable device; and the generating module is configured to: obtain a second display parameter of the display screen of the wearable device; perform a coordinate conversion on the coordinates of an acting point of the control operation on the display screen of the control terminal to obtain corrected coordinates according to a first display parameter of the display screen of the control terminal and the second display parameter; and generate the operation instruction according to a type of the control operation and the corrected coordinates.

In still yet another aspect, there is provided a non-transitory computer-readable storage medium having stored thereon the control method, wherein the instructions are stored on the non-transitory computer-readable storage medium, when run on a processing component, cause the processing component to perform the control methods applied to the wearable device in the above aspects.

In still yet another aspect, there is provided a non-transitory computer-readable storage medium having stored thereon the control method, wherein the instructions are stored on the non-transitory computer-readable storage medium, when run on a processing component, cause the processing component to perform the control methods applied to the control terminal in the above aspects.

In still yet another aspect, there is provided a control system for a wearable device. The control system comprises: a wearable device and a control terminal; wherein the wearable device comprises: the control device applied to the wearable device in the above aspects; and the control terminal comprises: the control device applied to the wearable device of the control terminal in the above aspects.

In still yet another aspect, there is provided a control system for a wearable device. The control system comprises: a wearable device and a control terminal; wherein the wearable device is configured to: establish a communication connection with the control terminal, the communication connection being established based on a connection establishment request carrying a direct connection control identifier; send display data of a display interface to the control terminal, the control terminal being configured to display the display interface on a display screen according to the display data; receive an operation instruction sent by the control terminal, the operation instruction being generated by the control terminal according to a received control operation for the display interface; and respond to the operation instruction; and the control terminal is configured to: establish a communication connection with the wearable device, the communication connection being established based on a connection establishment request carrying a direct connection control identifier; display a display interface on a display screen according to display data of the display interface sent by the wearable device; generate an operation instruction according to a received control operation for the display interface; and send the operation instruction to the wearable device.

### BRIEF DESCRIPTION OF THE DRAWINGS

FIG. 1 is a schematic diagram of an implementation environment related to a control method for a wearable device according to an embodiment of the present disclosure;

FIG. 2 is a flowchart of a control method for a wearable device according to an embodiment of the present disclosure;

FIG. 3 is a flowchart of another control method for a wearable device according to an embodiment of the present disclosure;

FIG. 4 is a flowchart of still another control method for a wearable device according to an embodiment of the present disclosure;

FIG. 5 is a schematic diagram of a display interface displayed on a display screen after a control terminal receives display data according to an embodiment of the present disclosure;

FIG. 6 is a flowchart of a method of generating an operation instruction by a control terminal according to the received control operation for the display interface according to an embodiment of the present disclosure;

FIG. 7 is a flowchart of a method for responding to an operation instruction by a wearable device according to an embodiment of the present disclosure;

FIG. 8 is a block diagram of a function of a directly connected control application installed in a wearable device and a control terminal according to an embodiment of the present disclosure;

FIG. 9 is a structural diagram of a control device of a wearable device according to an embodiment of the present disclosure; and

FIG. 10 is a structural diagram of a control device of another wearable device according to an embodiment of the present disclosure.

### DETAILED DESCRIPTION

Embodiments of the present disclosure will be described in further detail with reference to the enclosed drawings, to clearly present the principles and advantages of the present disclosure.

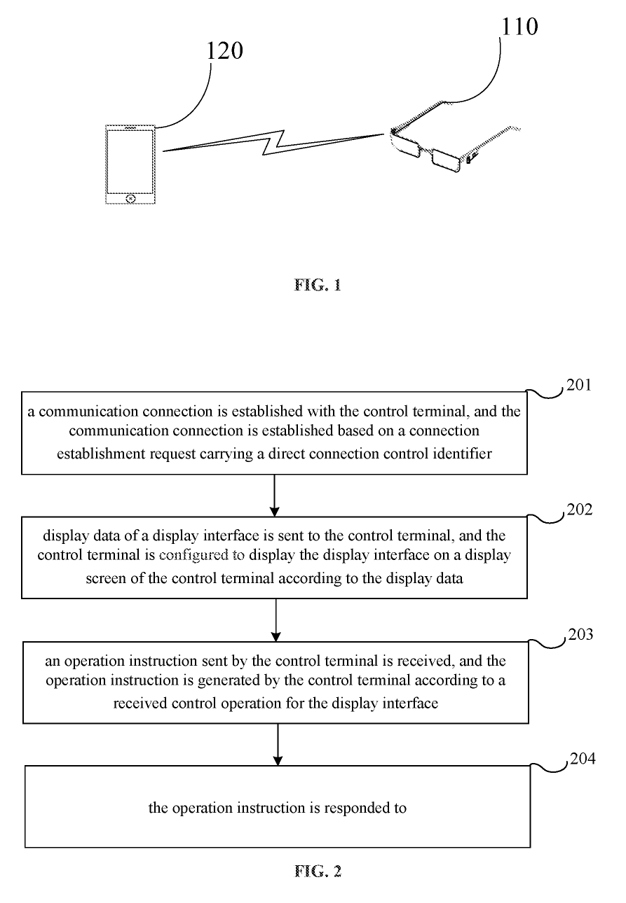

FIG. 1 is a schematic diagram of an implementation environment related to a control method for a wearable device according to an embodiment of the present disclosure. As shown in FIG. 1, the implementation environment may include a wearable device 110 and a control terminal 120. A connection may be established between the wearable device 110 and the control terminal 120 through a wireless network. The wearable device 110 may be a smart wristband, a smart watch or smart glasses, etc. The control terminal 120 may be a terminal having a display screen, such as a smart phone, a computer, a multimedia player, or an e-reader. The operating system used in the wearable device and the control terminal may both be an Android system.

FIG. 2 is a flowchart of a control method for a wearable device according to an embodiment of the present disclosure. The control method may be applied to the wearable device 110 shown in FIG. 1. As shown in FIG. 2, the control method may include the following processes.

In step 201, a communication connection is established with the control terminal, and the communication connection is established based on a connection establishment request carrying a direct connection control identifier.

In the embodiment of the present disclosure, the control terminal may scan an identification code labelled on the wearable device to be connected to obtain a device identifier of the wearable device to be connected. The control terminal then sends the connection establishment request to the wearable device to be connected according to the device identifier. The direct connection control identifier carried in the connection establishment request may be configured to indicate the control terminal to establish the communication connection with the wearable device. The communication connection may be a point-to-point connection, and data exchange may take place directly between two devices which are connected through a point-to-point connection, without forwarding by an intermediate node. For example, the point-to-point connection may be a wireless-fidelity (WIFI) direct connection. The wearable device establishes a WIFI direct connection with the control terminal, and data exchange may take place directly without forwarding by an intermediate node such as a server.

In step 202, display data of a display interface is sent to the control terminal, and the control terminal is configured to display the display interface on a display screen of the control terminal according to the display data.

The wearable device may process the display data of the display interface of the wearable device according to a preset streaming media protocol, and send the processed display data to the control terminal. The control terminal may display the display interface on the display screen of the control terminal according to the display data, so that a user may control the wearable device according to the display interface displayed on the display screen of the control terminal.

In step 203, an operation instruction sent by the control terminal is received, and the operation instruction is generated by the control terminal according to a received control operation for the display interface.

After displaying the display interface on the display screen according to the display data, the control terminal may receive the control operation for the display interface, and then generate the operation instruction, and send the operation instruction to the wearable device.

In step 204, the operation instruction is responded to.

After receiving the operation instruction sent by the control terminal based on the established communication connection, the wearable device may respond to the operation instruction according to a pre-stored correspondence between the operation instruction and a response mode, and therefore, the wearable device may be controlled through the control terminal.

In summary, with respect to the control method for the wearable device according to the embodiment of the present disclosure, after establishing the communication connection with the control terminal, the wearable device may send the display data of the display interface of the wearable device to the control terminal, and may receive and respond to the operation instruction for the display interface sent by the control terminal. Since the size of the display screen of the control terminal is generally large, there are many types of the control operations that the control terminal may receive through the display screen, and thus the types of the operation instructions that the wearable device may respond to may be enriched. The control method for the wearable device is diverse, and the flexibility of use thereof is high.

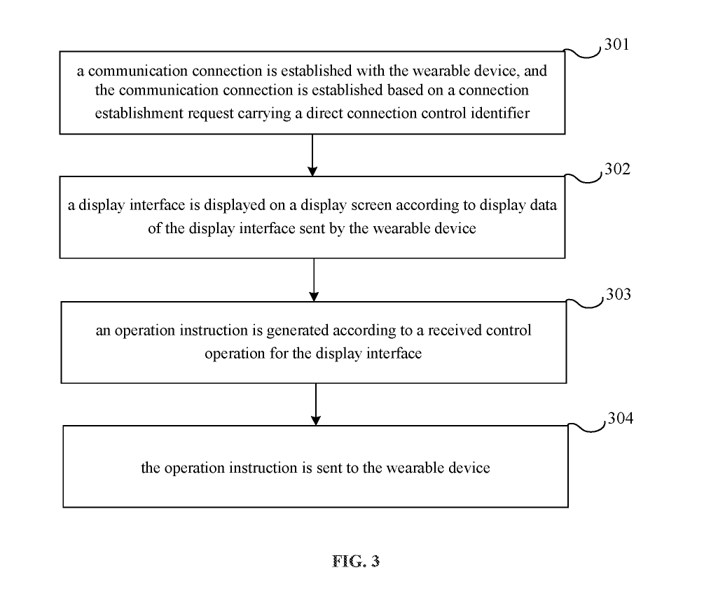

FIG. 3 is a flowchart of another control method for a wearable device according to an embodiment of the present disclosure. The control method may be applied to the control terminal 120 shown in FIG. 1. As shown in FIG. 3, the control method may include the following processes.

In step 301, a communication connection is established with the wearable device, and the communication connection is established based on a connection establishment request carrying a direct connection control identifier.

In the embodiment of the present disclosure, the control terminal may scan an identification code labelled on the wearable device to be connected to obtain a device identifier of the wearable device to be connected, and then send the connection establishment request to the wearable device to be connected according to the device identifier. The direct connection control identifier carried in the connection establishment request may be configured to indicate the control terminal to establish the communication connection with the wearable device. The communication connection may be a point-to-point connection, and may be, for example, a WIFI direct connection. The wearable device establishes a WIFI direct connection with the control terminal, and data exchange may take place directly without forwarding by an intermediate node such as a server.

In step 302, a display interface is displayed on a display screen according to display data of the display interface sent by the wearable device.

After receiving the display data, the control terminal may parse the display data according to a preset streaming media protocol. Thereafter, the control terminal may display the display interface on the display screen of the control terminal according to the parsed display data, so that a user may control the wearable device according to the display interface displayed on the display screen of the control terminal.

In step 303, an operation instruction is generated according to a received control operation for the display interface.

After displaying the display interface on the display screen according to the display data, the control terminal may receive the control operation for the display interface, and then generate the operation instruction. The control operation may include at least one of a touch operation (such as a single-click operation or a slide operation) and a voice operation.

In step 304, the operation instruction is sent to the wearable device.

After receiving the operation instruction, the control terminal may send the operation instruction to the wearable device based on the established communication connection, and therefore the wearable device may be controlled through the control terminal.

In summary, with respect to the control method for the wearable device according to the embodiment of the present disclosure, after establishing the communication connection with the wearable device, the control terminal may display the display interface on the display screen according to the display data of the display interface sent by the wearable device. Furthermore, the control terminal may also generate the operation instruction according to the received control operation, and may send the operation instruction to the wearable device. Since the size of the display screen of the control terminal is generally large, there are many types of the control operations that the control terminal may receive through the display screen of the control terminal, and thus the types of the operation instructions sent by the control terminal may be enriched. The control method for the wearable device is diverse, and the flexibility of use thereof is high.

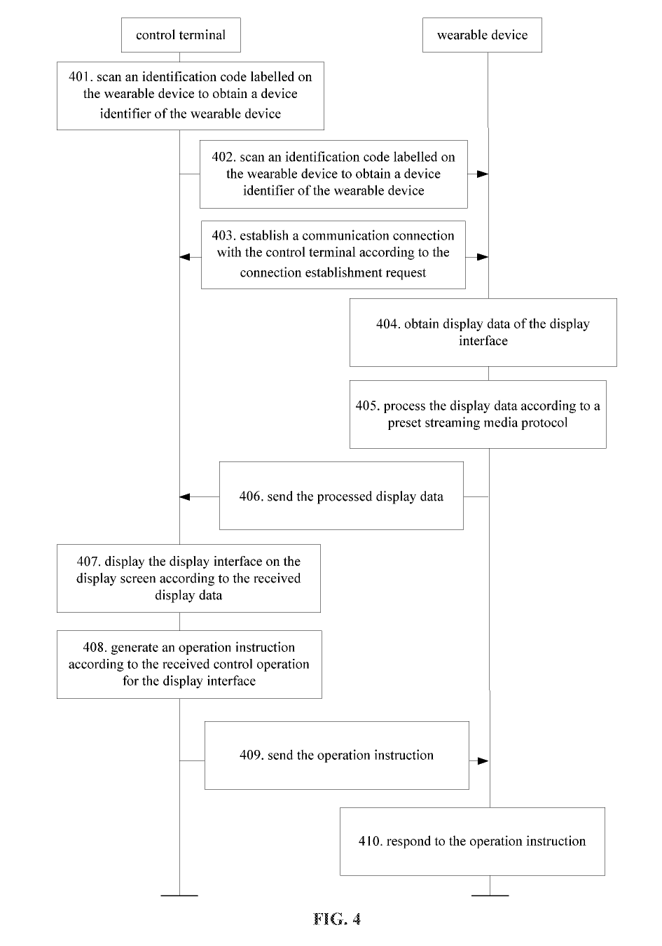

FIG. 4 is a flowchart of still another control method for a wearable device according to an embodiment of the present disclosure. The control method may be applied to the implementation environment shown in FIG. 1. As shown in FIG. 4, the control method may include the following processes.

In step 401, a control terminal scans an identification code labelled on the wearable device to obtain a device identifier of the wearable device.

In the embodiment of the present disclosure, the identification code may be pre-identified on the wearable device, and the identification code may be a two-dimensional code or a bar code, etc. which is generated after the device identifier of the wearable device is encoded. The device identifier may be a pre-configured identifier which may uniquely indicate the wearable device. For example, the device identifier may be a factory serial number or a physical address of the wearable device, etc. The control terminal may obtain the device identifier of the wearable device to be connected by scanning the identification code on the wearable device to be connected and decoding the identification code.

In the embodiment of the present disclosure, after scanning the identification code labelled on the wearable device to be connected, the control terminal may obtain the device identifier of the wearable device directly, without requiring a user to manually select the device identifier of the wearable device to be connected, which effectively simplifies the user operation and the exchange steps between the wearable device and the control terminal, and improves the efficiency of the control terminal to obtain the device identifier of the wearable device.

Exemplarily, it is assumed that the wearable device is smart glasses, the control terminal is a smart phone, and the device identifier of the smart glasses is its factory serial number 1111, and a two-dimensional code is identified on the frame of the smart glasses, which is generated after the factory serial number 1111 is encoded. Then, when a user needs to control the smart glasses through the smart phone, he/she may control the smart phone to turn on a camera thereof. The smart phone may then scan the two-dimensional code on the frame of the smart glasses through the camera, so as to obtain the device identifier 1111 of the smart glasses.

It should be noted that, when the user needs to control the wearable device through the control terminal, he/she may also control the control terminal to turn on a wireless connection function thereof (for example, Bluetooth connection function). At this point, the control terminal may scan the devices which may be connected in a preset range, and display the device identifiers of the devices which may be connected on the display screen of the control terminal. The user may select the device identifier of the wearable device to be connected according to a preset operation (e.g., a click operation). After detecting the preset operation, the control terminal may obtain the device identifier of the wearable device to be connected indicated by the preset operation.

Exemplarily, when the smart phone needs to establish a communication connection with the smart glasses, the user may turn on the Bluetooth connection function of the smart phone. At this point, the smart phone may scan the devices which may be connected in a preset range, and display the device identifiers of the devices which may be connected on the display screen of the smart phone. When detecting an operation of clicking on the device identifier 1111, the smart phone may obtain the device identifier 1111 of the smart glasses to be connected.

In step 402, the control terminal sends a connection establishment request to the wearable device according to the device identifier.

After obtaining the device identifier, the control terminal may send a connection establishment request to the wearable device indicated by the device identifier, and the connection establishment request carries a preset direct connection control identifier. The direct connection control identifier may be a pre-configured identifier in the control terminal and the wearable device for indicating to establish a point-to-point connection. For example, the direct connection control identifier may be a WIFI directly connected identifier.

Exemplarily, the smart phone may send a connection establishment request carrying the WIFI directly connected identifier to the smart glasses indicated by the device identifier 1111 according to the obtained device identifier 1111.

In step 403, the wearable device establishes a communication connection with the control terminal according to the connection establishment request.

When the connection establishment request sent by the control terminal which is received by the wearable device carries the direct connection control identifier, the wearable device may directly establish the communication connection with the control terminal according to the direct connection control identifier. For example, if the establishment request received by the wearable device carries the WIFI directly connected identifier, the wearable device may establish a WIFI direct connection with the control terminal based on the WIFI directly connected identifier.

In the embodiment of the present disclosure, when the wearable device detects that the connection establishment request carries the direct connection control identifier, the wearable device may directly establish the communication connection with the control terminal, without requiring a user to input a password or confirm the connection, which effectively simplifies the exchange steps between the wearable device and the control terminal, and improves the connection efficiency. Moreover, since a touchpad of the wearable device is generally small, it is inconvenient for the user to operate, the wearable device directly establishes the communication connection with the control terminal based on the connection establishment request, which may effectively simplify the user operation, and thus improve the user experience.

It should be noted that, the connection establishment request may also be sent by the wearable device to the control terminal. That is, an identification code for indicating the device identifier of the control terminal may also be identified on the body of the control terminal, or the control terminal may display the identification code through the display screen. The wearable device may obtain the device identifier of the control terminal by scanning the identification code, and then send a connection establishment request carrying a direct connection control identifier to the control terminal according to the device identifier. After receiving the connection establishment request, the control terminal may directly establish a communication connection with the wearable device.

In step 404, the wearable device obtains display data of the display interface of the wearable device.

After establishing the communication connection with the control terminal, the wearable device may obtain display data of the display interface of the wearable device in real time. The display data may include image data of an image displayed on the current display interface of the wearable device, and may also include a second display parameter of the display screen of the wearable device. The second display parameter may be the resolution or the size of the display screen of the wearable device.

In step 405, the wearable device processes the display data according to a preset streaming media protocol.

In the embodiment of the present disclosure, the streaming media protocol based on which the wearable device transmits the display data may include Real-time Transport Protocol (RTP) or Real Time Streaming Protocol (RTSP), etc. Exemplarily, the wearable device may encode and stream the display data of the current display interface of the wearable device according to the streaming media protocol in real-time (that is, package the encoded display data into a data packet).

In step 406, the wearable device sends the processed display data to the control terminal.

Further, the wearable device may send the processed display data to the control terminal according to the communication connection with the control terminal. Exemplarily, the wearable device may send the streamed data packet to the control terminal.

After directly establishing the communication connection with the wearable device, the control terminal may exchange data with the wearable device in addition to controlling the wearable device. Therefore, in order to distinguish the scenario of controlling from the scenario of exchanging other data, as an alternative implementation, the connection establishment request sent by the control terminal may also carry an operation control identifier for indicating to control the wearable device. After receiving the connection establishment request, the wearable device may detect whether the connection establishment request carries the operation control identifier, and may perform the above method shown in the steps 404 to 406 after detecting the operation control identifier. If the wearable device does not detect the operation control identifier, it may only establish the communication connection with the control terminal, and it does not need to obtain, process, and send the display data.

Exemplarily, a directly connected control application may be installed in the control terminal. After the control terminal launches the directly connected control application, the directly connected control application may, when detecting a user-triggered connection operation (for example, the operation of clicking a connection icon on an application interface), obtain an identifier of the wearable device to be connected, and send a connection establishment request carrying the operation control identifier to the wearable device.

As another alternative implementation, after establishing the communication connection with the control terminal, the wearable device may then send the display data to the control terminal after receiving the operation control instruction. The operation control instruction may be generated by triggering by the wearable device after detecting a user's specified operation (for example, a tap operation, an operation of pressing a designated button, a voice operation, etc.). Or, the operation control instruction may also be sent to the wearable device after the control terminal detects the user's specified operation (for example, an operation of clicking a control icon on the application interface or a voice operation, etc.).

In step 407, the control terminal displays the display interface on the display screen of the control terminal according to the received display data.

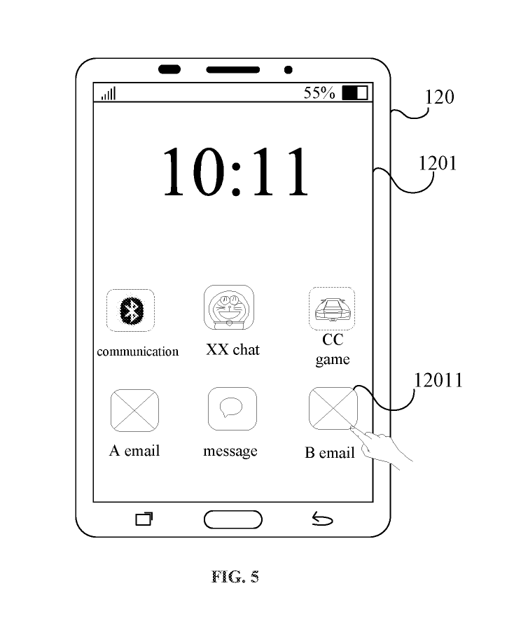

After receiving the processed display data sent by the wearable device, the control terminal may parse the streamed data packet to obtain the encoded display data according to the preset streaming media protocol. Thereafter, the control terminal may decode the encoded display data, and display the display interface of the wearable device on the display screen of the control terminal according to the decoded display data, so that the user may control the wearable device according to the display interface displayed on the display screen of the control terminal. Referring to FIG. 5, after receiving the display data, the control terminal 120 may display the display interface of the wearable device on the display screen 1201 of the control terminal 120.

Since the wearable device sends the display data to the control terminal based on the streaming media protocol in the embodiment of the present disclosure, the display interface of the wearable device may be synchronized to the display screen of the control terminal in real time, so that the user may precisely control the wearable device according to the real-time synchronized display interface.

In step 408, the control terminal generates an operation instruction according to the received control operation for the display interface.

In an alternative implementation of the embodiment of the present disclosure, the display screen of the control terminal may be a touch display screen. After displaying the display interface of the wearable device on the display screen of the control terminal, the control terminal may receive a control operation performed by the user on the display screen, such as a single-click operation, a long press operation, or a slide operation, and may generate the operation instruction according to the received control operation.

In another alternative implementation of the embodiment of the present disclosure, a voice recognition module may also be provided in the control terminal. After displaying the display interface of the wearable device on the display screen of the control terminal, the control terminal may also receive and recognize a voice operation for the display interface through the voice recognition module, and generate an operation instruction according to the voice operation. For example, the voice recognition module may convert the received voice operation into a character string, and then generate the operation instruction according to the character string.

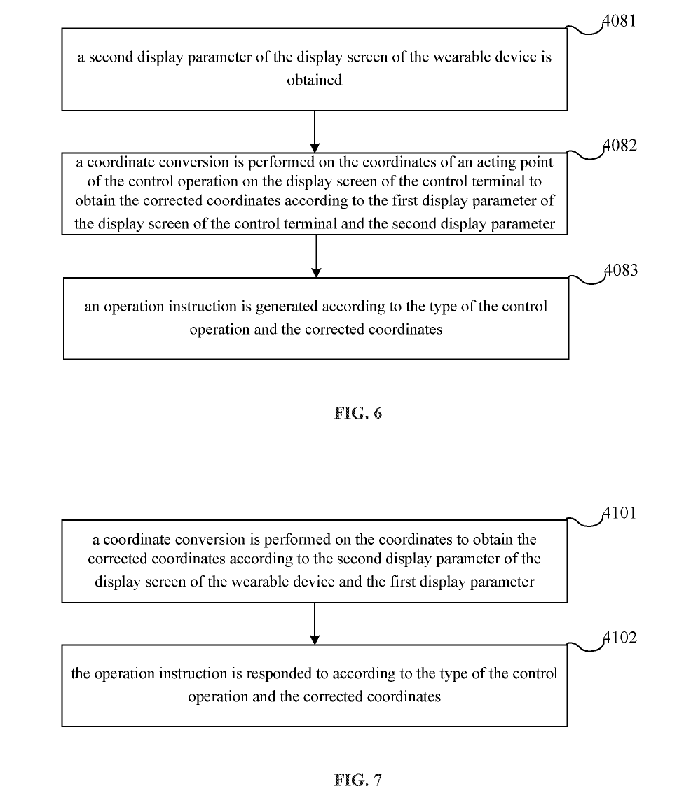

As shown in FIG. 6, the step that the control terminal generates the operation instruction according to the received control operation for the display interface may include the following processes.

In step 4081, a second display parameter of the display screen of the wearable device is obtained.

In the embodiment of the present disclosure, as an alternative implementation, when the wearable device sends the display data, the display data may carry a second display parameter of the display screen of the wearable device, and the control terminal may obtain the second display parameter form the received display data. As another alternative implementation, the identification code of the wearable device may carry the second display parameter of the display screen of the wearable device, and the control terminal may synchronously obtain the second display parameter of the display screen of the wearable device during the process of scanning the identification code to obtain the device identifier of the wearable device.

In step 4082, a coordinate conversion is performed on the coordinates of an acting point of the control operation on the display screen of the control terminal to obtain the corrected coordinates according to the first display parameter of the display screen of the control terminal and the second display parameter.

The first display parameter may be the resolution or the size of the display screen of the control terminal. Since the first display parameter of the display screen of the control terminal and the second display parameter of the display screen of the wearable device may be different, if the coordinates of an acting point of the control operation on the display screen of the control terminal is directly applied to the display screen of the wearable device, it may result in that the display object indicated by the coordinates on the display screen of the wearable device may be different from the display object indicated by the coordinates on the display screen of the control terminal. Therefore, in order to ensure accurate control of the wearable device, when the control terminal receives the control operation, the coordinates of the acting point of the control operation needs to be converted to obtain corrected coordinates according to the first display parameter of the display screen of the control terminal and the second display parameter of the display screen of the wearable device. The relative position of the corrected coordinates on the display interface of the wearable device is consistent with the relative position of the coordinates before correction on a display interface of the control terminal.

It should be noted that, in order to ensure that the coordinates of the acting point of the control operation may be normally converted, the type of the first display parameter should be the same as the type of the second display parameter. That is, when the first display parameter is resolution, the second display parameter should also be resolution; and when the first display parameter is the size of the display screen, the second display parameter should also be the size of the display screen.

Optionally, in the embodiment of the present disclosure, a coordinate conversion may be performed on the coordinates by the control terminal according to a ratio of the first display parameter and the second display parameter. For example, if both the first display parameter and the second display parameter are resolution, and the resolution of the display screen of the control terminal is m*n, and the resolution of the display screen of the wearable device is k*f, then, when the coordinates of the acting point of the control operation received by the control terminal on the display screen of the control terminal is (x1, y1), the corrected coordinates obtained after the control terminal corrects the coordinates (x1, y1) according to the first display parameter and the second display parameter may be (X1, Y1). X1 satisfies: X1=k*x1/m, and Y1 satisfies: Y1=f*y1/n. In addition, in the embodiment of the present disclosure, the coordinates may be in unit of millimeters.

Exemplarily, it is assumed that the resolution of the display screen of the control terminal is 1920*1080, i.e., m=1920, n=1080, and the resolution of the display screen of the wearable device is 1280*720, i.e., k=1280, f=720. As shown in FIG. 5, if a user clicks the icon of B mail application on the display screen 1201 of the control terminal 120 by a single-click operation, the control terminal may detect that the coordinates of the acting point of the control operation on the display screen 1201 is (10, 20), i.e., x1=10, x2=20. Further, the control terminal may convert the coordinates (10, 20) according to the resolution of the display screen of the control terminal and the resolution of the display screen of the wearable device, and the abscissa X1 of the corrected coordinates obtained after the conversion may be: X1=1280*10/1920=6.6, the ordinate Y1 of the corrected coordinates obtained after the conversion may be: Y1=720*20/1080=13.3, i.e., the corrected coordinates are (6.6, 11.3).

When both the first display parameter and the second display parameter are the size of the display screen, the process that the control terminal corrects the coordinates according to the first display parameter and the second display parameter may refer to the above process of performing a coordinate conversion according to the resolution, which will not be described again here.

It should also be noted that, if the control operation received by the control terminal is a touch operation, the control terminal may directly obtain the coordinates of the acting point of the touch operation according to the touch operation; and if the control operation received by the control terminal is a voice operation, the control terminal may convert the received voice operation into a corresponding character string through a voice recognition module, and then obtain the coordinates indicated by the voice operation according to the character string.

For example, it is assumed that the voice operation received by the control terminal is a voice of “deleting a CC game”, the control terminal may convert the voice operation into a corresponding character string through the voice recognition module, and obtain the coordinates of the icon of the “CC Game” application in the voice operation on the display screen of the control terminal according to the character string. And then, a coordinate conversion may be performed on the coordinates to obtain the corrected coordinates according to the first display parameter and the second display parameter.

It should also be noted that, according to the different types of the control operations, the number of the coordinates of the acting point obtained by the control terminal differs. For example, when the control operation is a single-click operation, a double-click operation, or a long press operation, the control terminal may obtain the coordinates of an acting point. When the control operation is a slide operation, the control terminal may obtain start coordinates of a start acting point of the slide operation and end coordinates of an end acting point. Or, in addition to the start coordinates and the end coordinates, the control terminal may also obtain the coordinates of a plurality of other acting points on the sliding track of the slide operation. Correspondingly, when the control terminal obtains the coordinates of a plurality of acting points, a coordinate conversion needs to be performed on the coordinates of each of the acting points, respectively.

In step 4083, an operation instruction is generated according to the type of the control operation and the corrected coordinates.

In the embodiment of the present disclosure, after receiving the control operation, the control terminal may also identify the type of the control operation, and generate the operation instruction according to the type of the control operation and the corrected coordinates. The type of the control operation may include a slide operation, a single-click operation, a double-click operation, a long press operation, etc. When the control operation is a touch operation, the control terminal may identify the type of the touch operation according to the operation duration and the moving distance of the touch operation. When the control operation is a voice operation, the control terminal may identify the type of the voice operation according to the character string obtained after the voice operation is converted; or, the control terminal may also directly recognize the response mode indicated by the voice operation according to the character string, and the operation instruction may also carry the response mode.

After recognizing the type of the control operation, the control terminal may generate the operation instruction according to the type of the control operation and the corrected coordinates. Exemplarily, Table 1 shows the parameters carried in each of the operation instructions generated by the control terminal. As shown in Table 1, if the type of the control operation received by the control terminal is a single-click operation, and the corrected coordinates are (6.6, 11.3), the operation instruction generated by the control terminal may be the operation instruction II shown in Table 1. Referring to the operation instruction I shown in Table 1, it can be seen that when the type of the control operation received by the control terminal is a slide operation, the corrected coordinates carried in the operation instruction may include the start coordinates (8, 11) of the start acting point and the end coordinates (10, 18) of the end acting point of the slide operation.

TABLE 1

| | Type of the Control | |
|---|---|---|
| Operation Instruction | Operation | Corrected Coordinates |
| operation instruction I | slide operation | start coordinates (8, 11) |
| | | end coordinates (10, 18) |
| operation instruction II | single-click operation | (6.6, 11.3) |
| operation instruction III | long press operation | (7, 20) |

It should be noted that, the control terminal may also not perform a coordinate conversion on the coordinates of the acting point of the control operation on the display screen of the control terminal. At this point, the control terminal may generate the operation instruction according to the type of the control operation, the coordinates, and the first display parameter of the display screen of the control terminal. Exemplarily, as shown in Table 2, if the type of the control operation received by the control terminal is a single-click operation, the coordinates of the acting point of the control operation detected by the control terminal on the display screen of the control terminal is (10, 20), and the resolution of the display screen of the control terminal is 1920*1080, the operation instruction generated by the control terminal may be the operation instruction V shown in Table 2.

TABLE 2

| | | | Resolution of the |
|---|---|---|---|
| Operation | Type of the Control | | Display Screen of the |
| Instruction | Operation | Coordinates | Control Terminal |
| operation | slide operation | start coordinates | 1920*1080 |
| instruction IV | | (4, 3) | |
| | | end coordinates | |
| | | (6, 10) | |
| operation | single-click | (10, 20) | 1920*1080 |
| instruction V | operation | | |
| operation | long press | (5, 8) | 1920*1080 |
| instruction VI | operation | | |

In step 409, the control terminal sends the operation instruction to the wearable device.

After generating the operation instruction, the control terminal may send the operation instruction to the wearable device based on the established communication connection. For example, the control terminal may send any of the operation instructions shown in Table 1 or Table 2 to the wearable device.

In step 410, the wearable device responds to the operation instruction.

After receiving the operation instruction, the wearable device may respond to the operation instruction according to a pre-stored correspondence between the operation instruction and the response mode, thereby enabling the control of the wearable device through the control terminal. In light of the difference of the display object indicated by the corrected coordinates in the operation instruction and the difference of the type of the control operation included in the operation instruction, the mode in which the wearable device responds to the operation instruction is different.

If the display object indicated by the corrected coordinates is an icon of an application, the wearable device may respond to the operation instruction according to the correspondence between the type of the control operation and the response mode shown in Table 3. Referring to Table 3, it can be seen that when the type of the control operation included in the operation instruction received by the wearable device is a slide operation, the response mode of the wearable device may be: moving the icon of the application along a sliding track of the slide operation.

TABLE 3

| Type of the Control Operation | Response mode |
|---|---|
| slide operation | move the icon along a sliding track |
| | indicated by the slide operation |
| single-click operation | turn on the application corresponding to |
| | the icon |
| long press operation | delete the application corresponding to |
| | the icon |

Exemplarily, it is assumed that the display object indicated by the corrected coordinates is an icon 12011 of the B mail application shown in FIG. 5, referring to the correspondence between the type of the control operation and the response mode shown in Table 3, when the type of the control operation included the operation instruction is a slide operation, the response mode of the wearable device may be: moving the icon of the B mail application along the sliding track of the slide operation; when the type of the control operation included in the operation instruction is a single-click operation, the response mode of the wearable device may be: turning on the B mail application; and when the type of the control operation included in the operation instruction is a long press operation, the response mode of the wearable device may be: deleting the B mail application.

It should be noted that, if the control terminal does not perform a coordinate conversion on the coordinates of the acting point of the control operation on the display screen of the control terminal after receiving the control operation, that is, when the operation instruction sent by the control terminal includes the first display parameter of the display screen of the control terminal, the type of the control operation, and the coordinates of the acting point of the control operation on the display screen of the control terminal, as shown in FIG. 7, the step that the wearable device responds to the operation instruction may include the following processes.

In step 4101, a coordinate conversion is performed on the coordinates to obtain the corrected coordinates according to the second display parameter of the display screen of the wearable device and the first display parameter.

The wearable device may perform a coordinate conversion on the coordinates to obtain the corrected coordinates according to the second display parameter of the display screen of the wearable device and the first display parameter carried in the operation instruction. For the implementation process of the conversion, reference may be made to the above step 4082, which will not be described again here.

In step 4102, the operation instruction is responded to according to the type of the control operation and the corrected coordinates.

Likewise, in light of the difference of the display object indicated by the corrected coordinates in the operation instruction and the difference of the type of the control operation included in the operation instruction, the mode in which the wearable device responds to the operation instruction is different. For the response mode, reference may be made to the mode in which the wearable device responds to the operation instruction in the above step 410, which will not be described again here.

Since an input module such as a touch display screen or a touchpad is not usually provided on a wearable device, or even if an input module is provided, the size of the input module is small. Therefore, the control terminal is used as a control device and an input device in the wearable device, there is no need to connect an input device such as an external keyboard or mouse via an OTG (On-The-Go) data line, which greatly facilitates the user operation.

It should be noted that, in the embodiment of the present disclosure, a preset directly connected control application (APP) may be installed in the wearable device and the control terminal. The control method executed in the wearable device in the embodiment shown in FIG. 4 may be performed by the directly connected control application in the wearable device. Correspondingly, the control method executed in the control terminal in the embodiment shown in FIG. 4 may be performed by the directly connected control application in the control terminal.

It should also be noted that, in the above step 410, after the wearable device receives the operation instruction sent by the control terminal, in order to ensure that the operating system of the wearable device may normally respond to the operation instruction, the directly connected control application in the wearable device may convert the operation instruction into an instruction that the operating system may recognize, and broadcast the converted operation instruction to the operating system.

FIG. 8 is a functional block diagram of a directly connected control application installed in a wearable device and a control terminal according to an embodiment of the present disclosure. As shown in FIG. 8, the directly connected control APP of the wearable device may include a WIFI module, a streaming module, and an instruction parsing module. The streaming module is configured to send display data of the wearable device to the control terminal through the WIFI module after encoding and streaming the display data of the wearable device; and the instruction parsing module is configured to parse an operation instruction received through the WIFI module, and sending the parsed operation instruction to an operating system of the wearable device. The directly connected control APP of the control terminal may include a WIFI module, a streaming extracting module, and an instruction obtaining module. The streaming extracting module is configured to stream extracting and decoding the display data received through the WIFI module, and playing (i.e. displaying) the decoded display data; and the instruction obtaining module is configured to detect a user's touch operation, and generating an operation instruction according to coordinates of an acting point of the touch operation, and sending the operation instruction to the wearable device through the WIFI module.

Further, referring to FIG. 8, it can be seen that a voice recognition module may also be provided in the control terminal. The voice recognition module may recognize a collected voice according to a preset recognition algorithm, obtain a character string corresponding to the voice, and send the character string to an instruction obtaining module, and the instruction obtaining module may generate an operation instruction based on the character string.

It should also be noted that, the sequence of the steps of the control method for the wearable device according to the embodiment of the present disclosure may be adjusted appropriately, and the steps may also be increased or decreased according to the situation. For example, the above step 401 may be omitted, that is, the control terminal may directly obtain the device identifier of the wearable device to be connected selected by the user. It will be apparent to those skilled in the art that alternations of the method are possible without departing from the protection scope of the present disclosure, which will not be described again here.

In summary, with respect to the control method for the wearable device according to the embodiment of the present disclosure, after establishing the communication connection with the control terminal, the wearable device may send the display data of the display interface of the wearable device to the control terminal. The control terminal may display the display interface on the display screen according to the display data. In addition, the control terminal may also generate an operation instruction according to the received control operation and may send the operation instruction to the wearable device. The wearable device may receive and respond to the operation instruction. Since the size of the display screen of the control terminal is generally large, there are many types of the control operations that the control terminal may receive through the display screen, and thus the types of the operation instructions that the control terminal sends may be enriched. The control method for the wearable device is diverse, and the flexibility of use thereof is high.

Moreover, by controlling the wearable device by the control terminal, a dedicated user interface (UI) may not be designed for the wearable device, which not only facilitates the user operation, but also reduces the manufacturing cost of the wearable device.

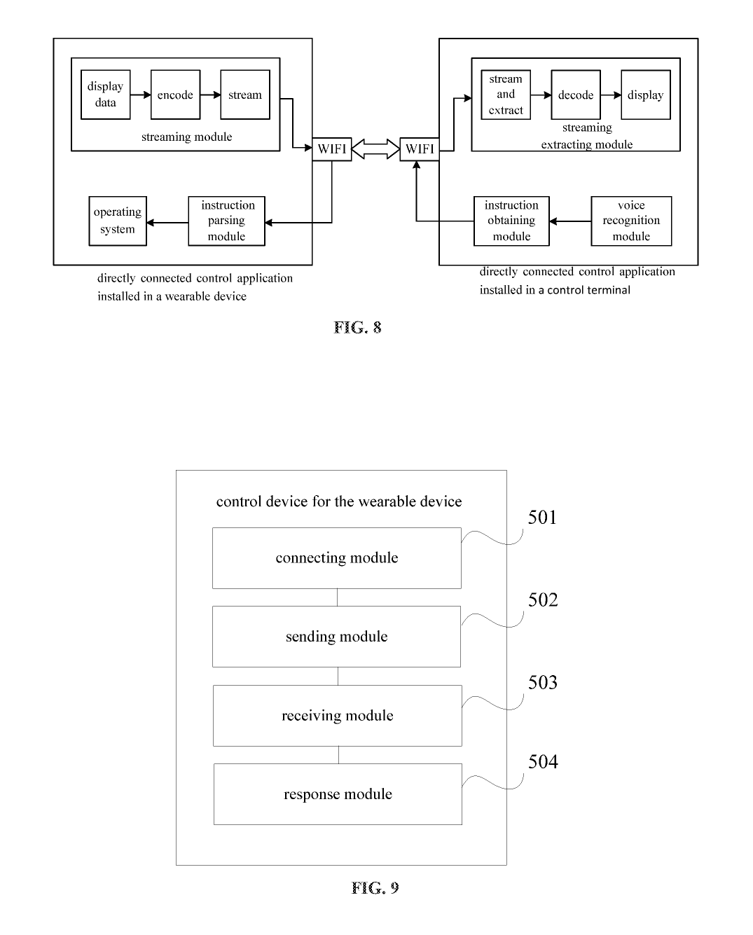

FIG. 9 is a schematic structural diagram of a control device for a wearable device according to an embodiment of the present disclosure. The control device may be applied to the wearable device 110 shown in FIG. 1. As shown in FIG. 9, the control device for the wearable device may include the following modules:

a connecting module 501, which is configured to establish a communication connection with a control terminal, wherein the communication connection is established based on a connection establishment request carrying a direct connection control identifier;

a sending module 502, which is configured to send display data of a display interface to the control terminal, wherein the control terminal is configured to display the display interface on a display screen of the control terminal according to the display data;

a receiving module 503, which is configured to receive an operation instruction sent by the control terminal, wherein the operation instruction is generated by the control terminal according to a received control operation for the display interface; and

a response module 504, which is configured to respond to the operation instruction.

Optionally, the sending module 502 may be configured to:

obtain the display data of the display interface; and

send the display data to the control terminal after being processed according to a streaming media protocol.

Optionally, a display screen is provided in the wearable device. The operation instruction includes a first display parameter of the display screen of the control terminal, a type of the control operation, and coordinates of an acting point of the control operation on the display screen of the control terminal. The response module 504 may be configured to:

perform a coordinate conversion on the coordinates to obtain corrected coordinates according to a second display parameter of the display screen of the wearable device and the first display parameter; and

respond to the operation instruction according to the type of the control operation and the corrected coordinates.

Optionally, both the first display parameter and the second display parameter are resolution; the response module 504 may be configured to:

perform a coordinate conversion on the coordinates according to a ratio of the first display parameter and the second display parameter.

As an alternative implementation, the connecting module 501 may be configured to:

receive the connection establishment request sent by the control terminal, wherein the connection establishment request is sent after the control terminal scans an identification code labelled on the wearable device to obtain a device identifier of the wearable device; and

establish the communication connection with the control terminal based on the connection establishment request.

Optionally, the sending module 502 may be configured to:

detect whether the connection establishment request carries an operation control identifier for indicating to control the wearable device; and

send the display data of the display interface to the control terminal when it is detected that the connection establishment request carries the operation control identifier.

As another alternative implementation, the connecting module 501 may be configured to:

scan the identification code identified on the control terminal to obtain a device identifier of the control terminal; and

send the connection establishment request to the control terminal to establish the communication connection with the control terminal according to the device identifier of the control terminal.

In summary, with respect to the control apparatus for the wearable device according to the embodiment of the present disclosure, after establishing the communication connection with the control terminal, the wearable device may send the display data of the display interface of the wearable device to the control terminal. Moreover, the wearable device may receive and respond to the operation instruction for the display interface sent by the control terminal. Since the size of the display screen of the control terminal is generally large, there are many types of the control operations that the control terminal may receive through the display screen, and thus the types of the operation instructions that the wearable device may respond to may be enriched. The flexibility of use thereof is improved.

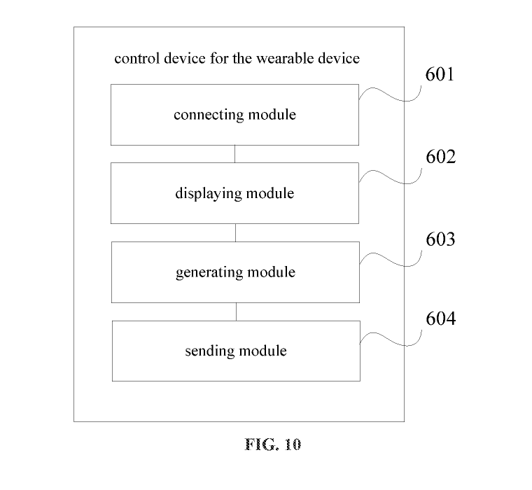

FIG. 10 is a schematic structural diagram of another control device for a wearable device according to an embodiment of the present disclosure. The control device may be applied to the control terminal 120 shown in FIG. 1. As shown in FIG. 10, the control device for the wearable device includes the following modules:

a connecting module 601, which is configured to establish a communication connection with the wearable device, wherein the communication connection is established based on a connection establishment request carrying a direct connection control identifier;

a displaying module 602, which is configured to display a display interface on a display screen of the control terminal according to display data of the display interface sent by the wearable device;

a generating module 603, which is configured to generate an operation instruction according to a received control operation for the display interface, wherein the control operation includes at least one of a touch operation and a voice operation; and

a sending module 604, which is configured to send the operation instruction to the wearable device.

Optionally, the displaying module 602 may be configured to:

process the display data according to a streaming media protocol; and

display the display interface on the display screen of the control terminal based on the processed display data.

Optionally, the connecting module 601 may be configured to:

scan an identification code labelled on the wearable device to obtain a device identifier of the wearable device; and

send the connection establishment request to the wearable device to establish the communication connection with the wearable device according to the device identifier.

Optionally, the connecting module 601 may be configured to:

receive the connection establishment request sent by the wearable device, wherein the connection establishment request is sent after the wearable device scans an identification code identified on the control terminal to obtain a device identifier of the control terminal; and

establish the communication connection with the wearable device based on the connection establishment request.

Optionally, a display screen is provided in the wearable device, and the generating module 603 may be configured to:

obtain a second display parameter of the display screen of the wearable device;

perform a coordinate conversion on the coordinates of an acting point of the control operation on the display screen of the control terminal to obtain corrected coordinates according to a first display parameter of the display screen of the control terminal and the second display parameter; and

generate the operation instruction according to a type of the control operation and the corrected coordinates.

Optionally, both the first display parameter and the second display parameter are resolution; the generating module 603 may be configured to perform a coordinate conversion according to a ratio of the first display parameter and the second display parameter.

In summary, with respect to the control apparatus for the wearable device according to the embodiment of the present disclosure, after establishing the communication connection with the control terminal, the wearable device may send the display data of the display interface of the wearable device to the control terminal. The control terminal may display the display interface on the display screen according to the display data. In addition, the control terminal may also generate an operation instruction according to the received control operation and may send the operation instruction to the wearable device. The wearable device may receive and respond to the operation instruction. Since the size of the display screen of the control terminal is generally large, there are many types of the control operations that the control terminal may receive through the display screen, and thus the types of the operation instructions that the control terminal sends may be enriched. The control method for the wearable device is diverse, and the flexibility of use thereof is high.

An embodiment of the present disclosure further provides a storage medium, which is a non-transitory computer-readable storage medium storing instructions. When the instructions in the non-transitory computer-readable storage medium run on a processing component, the processing component performs the control method for the wearable device which is applied to the wearable device, or the control method for the wearable device which is applied to the control terminal, according to the embodiments of the disclosure.

An embodiment of the present disclosure provides a control system for a wearable device. As shown in FIG. 1, the control system may include a wearable device 110 and a control terminal 120.

The wearable device 110 may include the control device for the wearable device as shown in FIG. 9.

The control terminal 120 may include the control device for the wearable device as shown in FIG. 10.

An embodiment of the present disclosure further provides a control system for a wearable device. As shown in FIG. 1, the control system may include a wearable device 110 and a control terminal 120.

The wearable device 110 may be configured to implement the control method for the wearable device applied to the wearable device in the above method embodiments.

The control terminal 120 may be configured to implement the control method for the wearable device applied to the control terminal in the above method embodiments.

Persons of ordinary skill in the art may clearly understand that for the convenience and conciseness of description, the specific working procedures of the apparatus and the modules thereof described above may be referenced to the corresponding procedures in the method embodiments, which are not repeated here.

The foregoing embodiments are only exemplary embodiments of the present disclosure, and are not intended to limit the present disclosure. Within the spirit and principles of the disclosure, any modifications, equivalent substitutions, improvements, etc., are within the scope of protection of the present disclosure.

What is claimed is:

1. A control method for a wearable device, which is applied to the wearable device, the control method comprising steps of:
establishing a communication connection with a control terminal, the communication connection being established based on a connection establishment request carrying a direct connection control identifier;
sending display data of a display interface to the control terminal, the control terminal being configured to display the display interface on a display screen according to the display data;
receiving an operation instruction sent by the control terminal, the operation instruction being generated by the control terminal according to a received control operation for the display interface; and
responding to the operation instruction.

2. The control method according to claim 1, wherein said step of sending the display data of the display interface to the control terminal comprises:
obtaining the display data of the display interface; and
sending the display data to the control terminal after being processed according to a streaming media protocol.

3. The control method according to claim 1, wherein a display screen is provided in the wearable device, and the operation instruction comprises a first display parameter of the display screen of the control terminal, a type of the control operation, and coordinates of an acting point of the control operation on the display screen of the control terminal;
said step of responding to the operation instruction comprises:
performing a coordinate conversion on the coordinates to obtain corrected coordinates according to the first display parameter and a second display parameter of the display screen of the wearable device; and
responding to the operation instruction according to the type of the control operation and the corrected coordinates.

4. The control method according to claim 3, wherein both the first display parameter and the second display parameter are resolution;
said step of performing a coordinate conversion on the coordinates according to the first display parameter and the second display parameter of the display screen of the wearable device comprises:
performing a coordinate conversion on the coordinates according to a ratio of the first display parameter and the second display parameter.

5. The control method according to claim 1, wherein said step of establishing the communication connection with the control terminal comprises:
receiving the connection establishment request sent by the control terminal, the connection establishment request being sent after the control terminal scans an identification code labelled on the wearable device to obtain a device identifier of the wearable device; and
establishing the communication connection with the control terminal based on the connection establishment request.

6. The control method according to claim 5, wherein said step of sending the display data of the display interface to the control terminal comprises:
detecting whether the connection establishment request carries an operation control identifier for indicating to control the wearable device; and
sending the display data to the control terminal when it is detected that the connection establishment request carries the operation control identifier.

7. A control method for a wearable device, which is applied to a control terminal, the control method comprising steps of:
establishing a communication connection with the wearable device, the communication connection being established based on a connection establishment request carrying a direct connection control identifier;
displaying a display interface on a display screen according to display data of the display interface sent by the wearable device;
generating an operation instruction according to a received control operation for the display interface; and
sending the operation instruction to the wearable device.

8. The control method according to claim 7, wherein said step of displaying the display interface on the display screen according to the display data of the display interface sent by the wearable device comprises:
processing the display data according to a streaming media protocol; and
displaying the display interface on the display screen based on the processed display data.

9. The control method according to claim 7, wherein said step of establishing the communication connection with the wearable device comprises:
scanning an identification code labelled on the wearable device to obtain a device identifier of the wearable device; and
sending the connection establishment request to the wearable device to establish the communication connection with the wearable device according to the device identifier.

10. The control method according to claim 7, wherein a display screen is provided in the wearable device; said step of generating the operation instruction according to the received control operation comprises:
obtaining a second display parameter of the display screen of the wearable device;
performing a coordinate conversion on the coordinates of an acting point of the control operation on the display screen of the control terminal to obtain corrected coordinates according to a first display parameter of the display screen of the control terminal and the second display parameter; and
generating the operation instruction according to a type of the control operation and the corrected coordinates.

11. A control apparatus for a wearable device, which is applied to the wearable device, and configured to implement the control method according to claim 1.

12. The control apparatus according to claim 11, wherein sending by the control apparatus the display data of the di splay interface to the control terminal comprises:
obtaining the display data of the display interface; and
sending the display data to the control terminal after being processed according to a streaming media protocol.

13. The control apparatus according to claim 11, wherein a display screen is provided in the wearable device, and the operation instruction comprises a first display parameter of the display screen of the control terminal, a type of the control operation, and coordinates of an acting point of the control operation on the display screen of the control terminal;
responding by the control apparatus to the operation instruction comprises:
performing a coordinate conversion on the coordinates to obtain corrected coordinates according to the first display parameter and a second display parameter of the display screen of the wearable device; and
responding to the operation instruction according to the type of the control operation and the corrected coordinates.

14. The control apparatus according to claim 11, wherein establishing by the control apparatus the communication connection with the control terminal comprises:
receiving the connection establishment request sent by the control terminal, the connection establishment request being sent after the control terminal scans an identification code labelled on the wearable device to obtain a device identifier of the wearable device; and
establishing the communication connection with the control terminal based on the connection establishment request.

15. A control apparatus for a wearable device, which is applied to a control terminal, and configured to implement the control method according to claim 7.

16. The control apparatus according to claim 15, wherein establishing by the control apparatus the communication connection with the wearable device comprises:
scanning an identification code labelled on the wearable device to obtain a device identifier of the wearable device; and
sending the connection establishment request to the wearable device to establish the communication connection with the wearable device according to the device identifier.

17. The control apparatus according to claim 15, wherein a display screen is provided in the wearable device; generating by the control apparatus an operation instruction according to a received control operation for the display interface comprises:
obtaining a second display parameter of the display screen of the wearable device;
performing a coordinate conversion on the coordinates of an acting point of the control operation on the display screen of the control terminal to obtain corrected coordinates according to a first display parameter of the display screen of the control terminal and the second display parameter; and
generating the operation instruction according to a type of the control operation and the corrected coordinates.

18. A non-transitory computer-readable storage medium, having stored thereon the control method according to claim 1, wherein instructions are stored on the non-transitory computer-readable storage medium, and when the instructions in the non-transitory computer-readable storage medium run on a processing component, the processing component performs the control method.

19. A non-transitory computer-readable storage medium, having stored thereon the control method according to claim 7, wherein instructions are stored on the non-transitory computer-readable storage medium, and when the instructions in the non-transitory computer-readable storage medium run on a processing component, the processing component performs the control method.

20. A control system for a wearable device, comprising the wearable device and a control terminal, wherein the wearable device is configured to:
establish a communication connection with the control terminal, the communication connection being established based on a connection establishment request carrying a direct connection control identifier;
send display data of a display interface to the control terminal, the control terminal being configured to display the display interface on a display screen according to the display data;
receive an operation instruction sent by the control terminal, the operation instruction being generated by the control terminal according to a received control operation for the display interface; and
respond to the operation instruction;
the control terminal is configured to:
establish a communication connection with the wearable device, the communication connection being established based on the connection establishment request carrying the direct connection control identifier;
display the display interface on the display screen according to the display data of the display interface sent by the wearable device;
generate an operation instruction according to a received control operation for the display interface; and
send the operation instruction to the wearable device.
